(19) United States
(12) Patent Application Publication
(10) Pub. No.: US 2015/0195687 A1
(43) Pub. Date: Jul. 9, 2015

(54) PUSH TO TALK VIRTUAL KEY

(71) Applicant: Shirley ALANSKY, Rockledge, FL (US)

(72) Inventor: Shirley ALANSKY, Rockledge, FL (US)

(21) Appl. No.: 14/589,666

(22) Filed: Jan. 5, 2015

Related U.S. Application Data
(60) Provisional application No. 61/923,404, filed on Jan. 3, 2014.

(51) Int. Cl. H04W 4/10; H04B 1/3827

(52) U.S. Cl. CPC H04W 4/10; H04B 1/385; H04B 2001/3861

(57) ABSTRACT

According to at least one exemplary embodiment, a Push-To-Talk virtual key may be disclosed. The virtual key may include a hardware adapter for connecting a headset, handset, or other PTT device to a computer. The virtual key may also include software that causes the PTT device to act as an input key on the computer keyboard, mouse, or other input device.

### PRIORITY CLAIM

This application claims priority to U.S. Provisional Application No. 61/923,404, filed Jan. 3, 2014, the contents of which are herein incorporated by reference.

### BACKGROUND

Audio headsets and handsets are used to send and receive audio transmissions by a variety of people in many situations. Push-To-Talk or Press-To-Talk (PTT) devices are often provided in audio headsets or handsets. PTT devices incorporate a button, switch, or other trigger that transitions between transmitting and receiving audio. Generally, pressing and holding the PTT button or switch may allow a user to transmit audio, while releasing the button or switch may allow receiving of audio. In typical operation, a user presses and holds a PTT button while speaking and releases the button after the user is finished speaking

Many scenarios exist where it may be beneficial to connect a headset, handset, or other PTT device to a computer. For example, but not limited to, situations for defense/military personnel, communications with PC-based radios, gaming, aviation, and simulation or training In these situations it may be desired to use the headset, handset, or other PTT device as it would be used when not connected to a computer, or in the case of simulation and training, to use the same headset, handset, or PTT device that would be used in a real situation.

### SUMMARY

According to at least one exemplary embodiment, a Push-To-Talk virtual key system may be disclosed. The system may include a push-to-talk device configured to transmit a signal when a push-to-talk button is pressed. The system may further include an adapter having a receiving connector configured to receive the signal from the push-to-talk device. The adapter may have a converter module for converting the signal to be communicated through a transmitting connector. The system may also include a computer configured to receive the converted signal from the transmitting connector. The computer may be configured to interpret a press of the push-to-talk button as a press of a predetermined keyboard or mouse key.

According to another exemplary embodiment, a push-to-talk virtual key method may be disclosed. The method may include providing a push-to-talk device configured to transmit a signal when a push-to-talk button is pressed. Next, a communication interface of the push-to-talk device may be connected to an adapter, which may be configured to convert the signal to be communicated through a Universal Serial Bus (“USB”) interface. The adapter may be connected to a computer through the USB interface. Software may be provided on a memory component of the computer to monitor signals from the push-to-talk device. The software may communicate to the operating system and other programs running on the computer that a predetermined key has been pressed when the software recognizes that a push-to-talk button is pressed.

According to yet another exemplary embodiment, a push-to-talk virtual key apparatus may be disclosed. The apparatus may include a push-to-talk device configured to transmit a signal when a push-to-talk button is pressed. There may also be an adapter having a receiving connector configured to receive the signal from the push-to-talk device. The adapter may include a converter module for converting the signal to be communicated through a transmitting connector. A computer may also be included and may be configured to receive the converted signal from the transmitting connector. The computer may have a processor and a memory component. One or more sequences of instructions may be stored on the memory component of the computer. When executed by the processor the instructions may carry out the following steps. Signals from the adapter may be monitored. Presses of the push-to-talk button may be recognized. The operating system and other programs running on the computer may be caused to act as though an input key on a keyboard or mouse has been pressed. Programs may be allowed to access signal data when the push-to-talk button is pressed. A release of the push-to-talk button may be recognized and subsequently the operating system and other programs running on the computer may be caused to act as though the input key is not pressed.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1 shows an exemplary embodiment of a Push-To-Talk virtual key.

FIG. 2 shows an exemplary diagram of a Push-To-Talk virtual key.

FIG. 3 shows an exemplary diagram of a Push-To-Talk virtual key.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein are described in terms of sequences of actions to be performed by, for example, elements of a computing device. It should be recognized by those skilled in the art that the various sequences of actions described herein can be performed by specific circuits (e.g. application specific integrated circuits (ASICs)) and/or by program instructions executed by at least one processor. Additionally, the sequence of actions described herein can be embodied entirely within any form of computer-readable storage medium such that execution of the sequence of actions enables the at least one processor to perform the functionality described herein. Furthermore, the sequence of actions described herein can be embodied in a combination of hardware and software. Thus, the various aspects of the present invention may be embodied in a number of different forms, all of which have been contemplated to be within the scope of the claimed subject matter. In addition, for each of the embodiments described herein, the corresponding form of any such embodiment may be described herein as, for example, “a computer configured to” perform the described action.

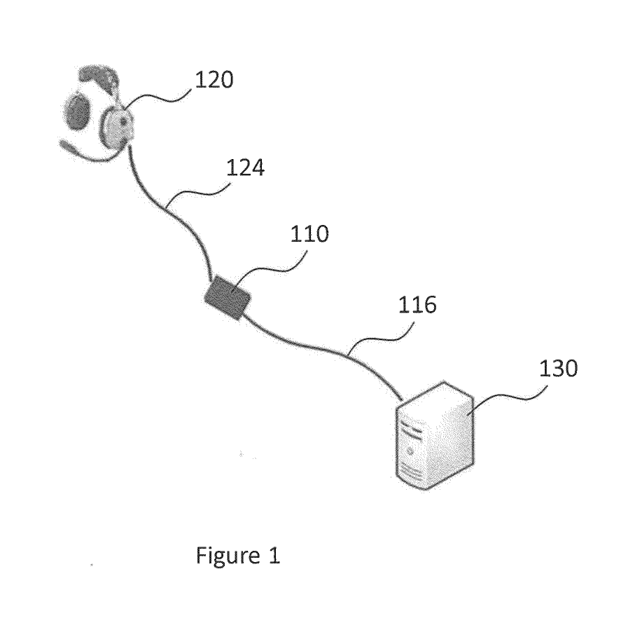

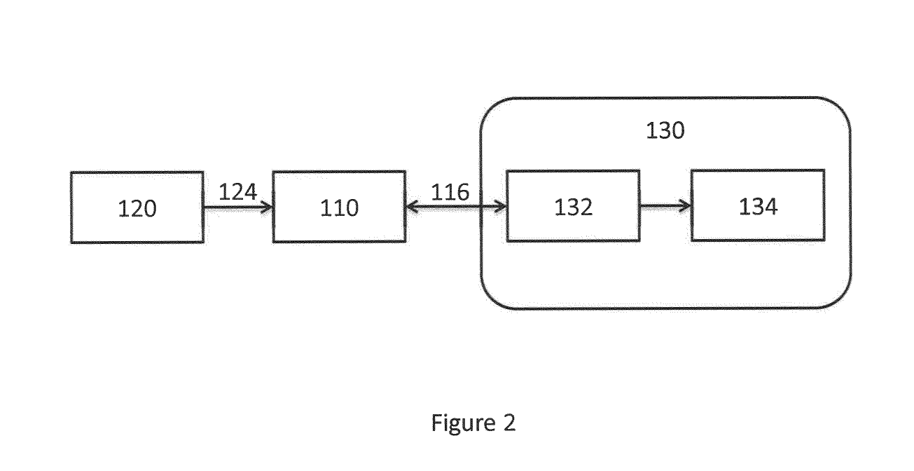

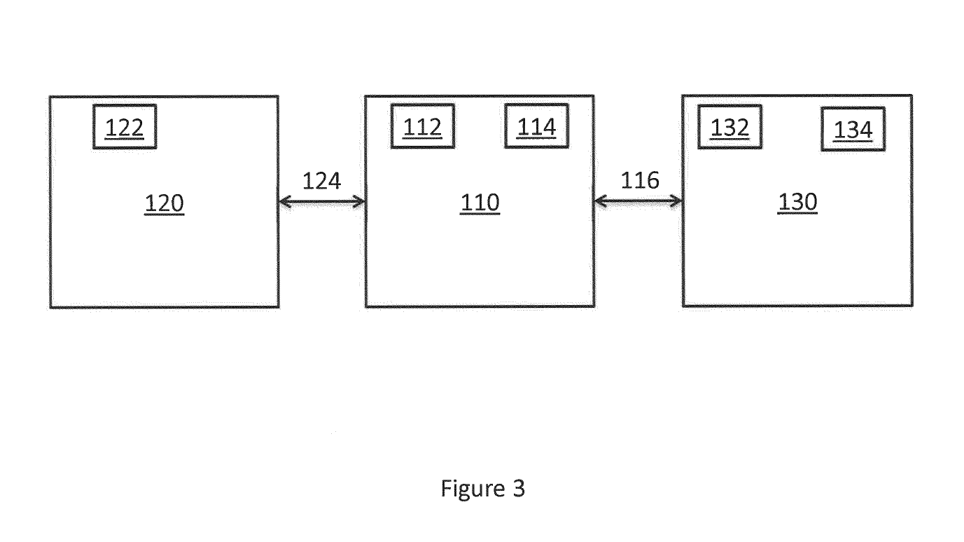

Referring generally to FIGS. 1-3, and according to at least one exemplary embodiment, a Push-To-Talk virtual key may be disclosed. In some exemplary embodiments, there may be a hardware adapter 110 for connecting a headset, handset, or other PTT device 120 to a computer 130 and there may be a software program 132 loaded on the computer 130 configured to monitor and work in conjunction with signals received through the connection from the headset, handset, or other PTT device 120. The software 132 may be stored on a memory component of the computer 130. Computer 130 may include a processor configured to perform the functions described herein. In some exemplary embodiments, the hardware adapter may connect to the computer by Universal Serial Bus (“USB”) connection 116. USB may define the cables, connectors, and communications protocols used in a bus for connection, communication, and power supply between computers and electronic devices. In alternative exemplary embodiments, other known connections may be used, as would be understood by a person having ordinary skill in the art. In such embodiments, the software program 132 may monitor signals received through the USB connection 116. Various other forms of connections may be used, as would be understood by a person having ordinary skill in the art. In some alternative embodiments, the connection 116 may be wireless, such as through Bluetooth or WiFi. The Push-To-Talk Virtual Key may also be implemented as just hardware or just software. One exemplary embodiment of the virtual key being implemented as just software may be if the headset, handset, or other PTT device were connected to the computer wirelessly. However, another exemplary embodiment of the virtual key may include hardware and software in situations involving wireless connectivity.

The hardware adapter 110 may allow a headset, handset, or other PTT device 120 to connect to a computer 130. The adapter 110 may permit signals to be transmitted from the PTT device 120 to the computer 130 and the adapter may permit signals to be transmitted from the computer 130 to the PTT device 120. In an exemplary embodiment, the hardware adapter 110 may be communicatively coupled to a computer 130 through a conventional USB port. For exemplary purposes, the following description may utilize a signal being transmitted from a PTT device 120 to a computer 130, however, it may be understood by a person having ordinary skill in the art that a signal may be transmitted from the computer 130 to the PTT device 120 in a similar manner. The hardware adapter 110 may accept the connector 124 of the headset, handset, or other PTT device and convert its transmissions to a USB connection 116 for use with a computer 130. An exemplary adapter 110 may include a converter module 112 for converting the transmission received from a PTT device 120 to a desired output transmission. In USB embodiments, the adapter 110 may further include a USB device controller 114 and a USB interface for connection 116 to a computer's USB port. This may allow the user of the handset, headset, or other PTT device 120 to send and receive audio signals with the computer 130 through the handset, headset, or other PTT device 120.

Often, the PTT button 122 is part of the headset, handset, or other device and may be connected in-line therewith. This may allow for one connector or interface 124 to connect the PTT device 120 with the adapter 110. The PTT device 120 may include a microphone, speaker, and PTT button. Connector 124 may include a microphone, speaker, and PTT button connection. The hardware adapter 110 may contain an appropriate receiving connector based on a desired headset, handset, or other PTT device 120. In an exemplary embodiment, the hardware adapter 110 may accept a U-283, XLR4F, XLR3M, XLR5M, XLR5F, XLR6M, PJ7, PJ-068/M642/5-1, PJ-055B/M642/4-1, and U-92/U/TJ-120. In alternative exemplary embodiments, the hardware adapter 110 may accept other handset, headset, or other PTT device connections as would be reasonably understood by a person having ordinary skill in the art. Alternative connections may further include wireless connections, such as, but not limited to Bluetooth, WiFi, radio frequency, infrared, or microwave transceivers. In yet further exemplary embodiments, the hardware adapter 110 may accept multiple connections as would be understood by a person having ordinary skill in the art. For ease of discussion, a U-283 connection may be detailed in the present description, however, corresponding functionality of alternative connections may be understood. In some exemplary embodiments, the hardware adapter may acquire all necessary power from the USB port with which it is connected. Therefore no batteries or external power may be necessary.

In some exemplary embodiments, the hardware adapter may include a power pass through for powering certain handsets, headsets, and other devices that may require power, such as for Active Noise Reduction technology. In headsets, handsets, and other PTT devices employing U-283 connectors, these devices may receive power through PIN F of the connector. In embodiments using alternative connectors, power may be passed through the connection in a similar fashion, as would be understood by a person having ordinary skill in the art. In an exemplary embodiment, the power pass through may provide a connection to an external power source such as a wall outlet and may transfer that power to the connection to the handset, headset, or other PTT device. For example, in an adapter with a U-283 connector, the power may pass into the adapter and may be output through the EXT pin of the U-283/U connector. In alternative embodiments, the power pass through may function as would be reasonably understood by a person having ordinary skill in the art.

In an exemplary embodiment, the virtual key software 132 may run in the background on a computer and may be compatible with third party software. The virtual key software may detect when a PTT button 122 is triggered on a handset, headset, or other PTT device and the virtual key software 132 may cause the computer, including the operating system and or other programs 134 running on the computer to act as though an input key for the computer has been depressed, such as a key on a keyboard or button on a mouse. The virtual key software may cause this to last as long as the PTT button 122 is triggered and the virtual key may cause the computer and or other programs 134 running on the computer to act as though the input key is no longer depressed when the PTT button is released. This may allow software or programs using a keyboard key press to trigger talking or transmitting voice to work with a PTT device. The desired computer input key or button may vary and in some exemplary embodiments it may be changed by a user. This may provide compatibility with a variety of third party programs. Adapters 110 may be uniquely addressable, allowing multiple adapters 110 to function when connected to a single computer 130. For exemplary embodiments that provide for multiple PTT devices 120 connected, different input keys may be mapped to different connected PTT's 122. An exemplary embodiment may work with simulators or programs that require the spacebar to be depressed for PTT simulation by causing the computer or program to act as though the spacebar is depressed with the handset, headset, or other PTT device's PTT button is triggered. With programs that allow flexibility, keys may be coordinated by a user. This may allow the user to transmit audio to the computer when pressing the PTT button and receive audio from the computer when the button 122 is released.

The virtual key may allow for multiple PTT devices connected to a single headset, handset, or microphone. The virtual key may also allow for various types of microphones as would be understood by a person having ordinary skill in the art, including electret and dynamic microphones.

An exemplary adapter and accompanying software may optionally be capable of producing zero-latency sidetone when a PTT button is pressed. Sidetone may be sounds from a user's microphone through the user's own headset. For example, when using radios, a user may hear the user's voice through their own headset. Producing sidetone may make the communication more authentic to traditional communications through the headset device. In some exemplary embodiments, the production of sidetone may selectively be turned on or off by a user.

An exemplary embodiment may work as follows. The hardware adapter may connect to a headset, handset, or other PTT device, allowing it to communicate with a computer. The software may listen or monitor the signals from the hardware adapter and may recognize the triggering of a PTT button. Upon triggering of a PTT button on the headset, handset, or other PTT device, the software may cause the computer, including the operating system and other programs running on the computer, to act as though an input key, such as the spacebar on a keyboard, has been pressed. The software may cause the computer and running programs to act as though the input key is depressed as long as the PTT button is triggered. This functionality may allow for the use of a headset, handset, or other PTT device to work with a communication program running on a computer. The signal communicated from the headset through the adapter and to the computer may include a button-press indication and an audio signal. In some embodiments, the transmission of an audio signal may indicate the button-press. This may also allow a user to communicate with the same device for both computer/PC based radios and non-computer/PC based radios. The virtual key may also work with third party software programs without requiring modifications. This may be because the third party software program was designed to work with a PC keyboard, which the virtual key mimics.

Exemplary operation may include a soldier using a PTT headset. The soldier may have the headset connected to a radio installed in a vehicle. The virtual key may allow the soldier to use the same headset when dismounted from the vehicle by disconnecting the headset from the vehicle radio, connecting the headset to a PC based radio through the virtual key hardware, and using the PC based radio or third party communication software with the headset and its PTT functions. In an alternative exemplary operation, it may allow the use and true functionality of a PTT headset when operated with a third party simulation program. These operations are exemplary operations and are not to be read as limiting.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A push-to-talk virtual key system comprising:
a push-to-talk device configured to transmit a signal when a push-to-talk button is pressed;
an adapter having a receiving connector configured to receive the signal from the push-to-talk device, the hardware adapter further comprising a converter module for converting the signal to be communicated through a transmitting connector; and
a computer configured to receive the converted signal from the transmitting connector, the computer further configured to interpret a press of the push-to-talk button as a press of a predetermined keyboard or mouse key.

2. The system of claim 1, wherein the transmitting connector is a USB interface.

3. The system of claim 1, wherein the receiving connector is a U-283 interface.

4. The system of claim 1, wherein the adapter further comprises a power pass-through for transmitting a power signal from an external source to the push-to-talk device.

5. The system of claim 4, wherein the power signal passes from the computer through a USB interface to the adapter and is passed through a U-283 interface to the push-to-talk device.

6. The system of claim 1, wherein the signal indicates a button-press and comprises an audio signal.

7. A push-to-talk virtual key method comprising:
providing a push-to-talk device configured to transmit a signal when a push-to-talk button is pressed;
connecting a communication interface of the push-to-talk device to an adapter configured to convert the signal to be communicated through a USB interface;
connecting the adapter to a computer through the USB interface;
providing software stored on a memory component of the computer to monitor signals from the push-to-talk device; and
allowing the software to communicate to the operating system and other programs running on the computer that a predetermined key has been pressed when the software recognizes that a push-to-talk button is pressed.

8. The method of claim 7, wherein the communication interface of the push-to-talk device is a U-283 interface.

9. The method of claim 8, further comprising passing power through the adapter from the USB interface to an EXT pin of a U-283 connector.

10. The method of claim 7, wherein the adapter further comprises a converter module and USB controller.

11. The method of claim 7, further comprising allowing a user to predetermine the key to be pressed by the software.

12. A push-to-talk virtual key apparatus comprising:
a push-to-talk device configured to transmit a signal when a push-to-talk button is pressed;
an adapter having a receiving connector configured to receive the signal from the push-to-talk device, the adapter further comprising a converter module for converting the signal to be communicated through a transmitting connector;
a computer configured to receive the converted signal from the transmitting connector, the computer having a processor and a memory component; and
one or more sequences of instructions stored on the memory component which, when executed by the processor, cause the processor to carry out the steps of:
monitoring signals from the adapter;
recognizing a press of the push-to-talk button;
causing the operating system and other programs running on the computer to act as though an input key on a keyboard or mouse has been pressed;
allowing programs to access signal data when the push-to-talk button is pressed;
recognizing when the push-to-talk button is released; and
causing the operating system and other programs running on the computer to act as though the input key is not pressed.

13. The apparatus of claim 12, wherein the transmitting connector is a USB interface.

14. The apparatus of claim 12, wherein the receiving connector is a U-283 interface.

15. The apparatus of claim 12, wherein the adapter further comprises a power pass-through for transmitting a power signal from an external source to the push-to-talk device.

16. The apparatus of claim 12, wherein the power signal passes from the computer through a USB interface to the adapter and is passed through a U-283 interface to the push-to-talk device.

17. The apparatus of claim 12, wherein the one or more sequences of instructions further cause the processor to carry out the step of producing sidetone to be transmitted to the push-to-talk device.
